(19) United States
(12) Patent Application Publication
(10) Pub. No.: US 2019/0327092 A1
(43) Pub. Date: Oct. 24, 2019

(54) METHODS AND SYSTEMS FOR SECURE BIOMETRIC AUTHENTICATION

(71) Applicant: Avago Technologies General IP (Singapore) Pte. Ltd., Singapore (SG)

(72) Inventor: Sreenadh KARETI, San Jose, CA (US)

(73) Assignee: Avago Technologies General IP (Singapore) Pte. Ltd., Singapore (SG)

(21) Appl. No.: 15/960,428

(22) Filed: Apr. 23, 2018

(51) Int. Cl. H04L 9/32; H04L 9/06; H04L 9/08; G06K 9/62

(52) U.S. Cl. CPC H04L 9/3231; G06K 9/6215; H04L 9/0825; H04L 9/0662

(57) ABSTRACT

In some aspects, the disclosure is directed to methods and systems for using biometric authentication on local or remote devices, without requiring a secure communication channel between the devices. An enrollment operation may be performed on a first device. The enrollment data and user credentials may be encrypted using a cryptography key generated using the biometric information. The encrypted enrollment data may be transferred to the remote device via any available communication channel regardless of its security. On the remote device, the cryptographic key may be regenerated using newly captured biometric data, and the enrollment data and user credentials decrypted. This allows the user to completely eliminate the use of passwords and re-enrollment of biometric authentication on the remote device.

### FIELD OF THE DISCLOSURE

This disclosure generally relates to systems and methods for secure biometric authentication. In particular, this disclosure relates to systems and methods for securely exchanging biometric comparison data between devices without requiring a secure communication channel.

### BACKGROUND OF THE DISCLOSURE

Biometric data, such as fingerprint data, voice data, iris data, or other such data, may be used as unique and difficult to copy or intercept identifiers of a user. For example, a device may capture a thumb or fingerprint of a user and compare it to a previously captured thumb or fingerprint. If the prints match, then the user may be identified as the user that provided the previously captured thumb or fingerprint, and may be authenticated.

Such biometric authentication systems may be most secure when utilized on a single device—that is, with original and new biometric data captured on the same device, such that the data never needs to be transmitted to another device. However, as biometric data is useful for user authentication, some systems allow communication of biometric data between devices. For example, a user may first enroll or capture biometric data on a first device. The biometric data or a template or profile may be provided to a second device. The second device may then capture biometric data of the user, compare the captured data to the template or profile, and authenticate the user.

Although such systems are useful for allowing password-free authentication of users, they require a secure communication channel between the devices: interception of the biometric template or profile during communication between the devices, or otherwise exfiltrating the template or profile destroys the security of the biometric system. For example, if the template represents a captured voice recording or fingerprint, a malicious attacker that intercepts the template may provide it to a system as if it were a new capture. Because the new capture will necessarily match the intercepted template, the system may erroneously authenticate the attacker.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an implementation of a system for biometric authentication;

FIG. 2A is a block diagram of an implementation of a system for data security via biometric key generation and exchange via insecure data channels;

FIGS. 2B and 2C are block diagrams of another implementation of a system for data security via biometric key generation and exchange via insecure data channels;

FIG. 3 is a flow chart of an implementation of a method for data security via biometric key generation and exchange via insecure data channels;

FIG. 4A is a block diagram depicting an embodiment of a network environment including one or more access points in communication with one or more devices or stations; and

FIGS. 4B and 4C are block diagrams depicting embodiments of computing devices useful in connection with the methods and systems described herein.

The details of various embodiments of the methods and systems are set forth in the accompanying drawings and the description below.

### DETAILED DESCRIPTION

The following IEEE standard(s), including any draft versions of such standard(s), are hereby incorporated herein by reference in their entirety and are made part of the present disclosure for all purposes: IEEE P802.11n™; and IEEE P802.11ac™. Although this disclosure may reference aspects of these standard(s), the disclosure is in no way limited by these standard(s).

For purposes of reading the description of the various embodiments below, the following descriptions of the sections of the specification and their respective contents may be helpful:
Section A describes embodiments of systems and methods for secure biometric authentication; and
Section B describes a network environment and computing environment which may be useful for practicing embodiments described herein.

### A. Systems and Methods for Secure Biometric Authentication

The use of passwords for authentication has been widely used for everything from computer logon to accessing bank accounts over the Internet. However, password security is frequently lacking, with myriad attacks and billions of user accounts compromised, with potential attack vectors including dictionary or brute force attacks; hardware or software keyloggers; credential stuffing, or using stolen credentials from one online account to access other valuable accounts; theft of databases storing credentials in either plaintext or readily broken cyphertext; phishing and social engineering attacks to trick users into clicking a malicious link or entering credentials on false site; etc.

One solution to thwart password attacks is to use biometric features such as a fingerprint, facial identification, voice identification, iris identification, etc. Biometric authentication typically works in two stages: first, a user enrolls his or her biometric sample, and biometric features are extracted and a template is generated. Second, to authenticate the user, the user presents his or her biometric sample, and the device matches the sample against the enrolled template.

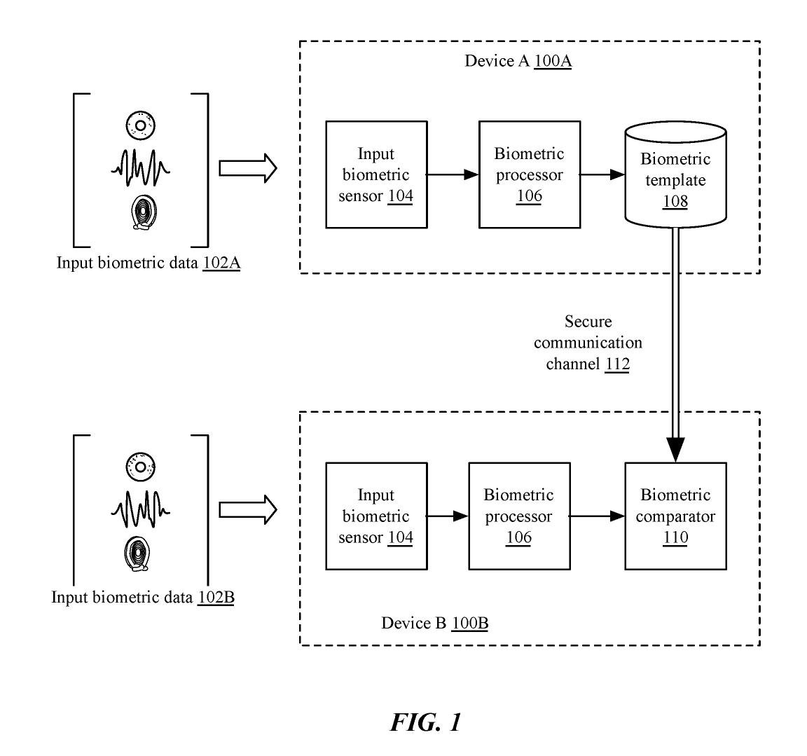

Such biometric authentication systems may be most secure when utilized on a single device—that is, with original and new biometric data captured on the same device, such that the data never needs to be transmitted to another device. However, as biometric data is useful for user authentication, some systems allow communication of biometric data between devices. For example, FIG. 1 is a block diagram of an implementation of a system for biometric authentication. As shown, a user may first enroll or capture biometric data 102A on a first device A 100A. Device A 100A may comprise any type and form of device incorporating an input biometric sensor 104, such as a smartphone; a desktop computer; a laptop computer; a tablet computer; a wearable computer; a smart appliance (e.g. an Internet of Things or IoT device); a smart car with keyless entry; etc. Sensor 104 may comprise any type and form of sensor for capturing biometric feature, such as a fingerprint sensor, camera, or microphone. The biometric sensor 104 output may be processed by a biometric processor 106, which may comprise circuitry and/or software for identifying salient features of the biometric data capture. For example, in some implementations, biometric processor 106 may comprise a circuit configured to compress and filter input audio to generate a unique signature. In other implementations, biometric processor 106 may comprise an application or service executed by a processor of device A 100A and configured to filter a fingerprint image and extract minutiae points corresponding to a predetermined set of fingerprint features (e.g. ridge endings, bifurcations or mergers, deltas, etc.). These features or points may be identified by x-y coordinates within the fingerprint image, as well as an angle corresponding to the direction of the feature (e.g. along a ridge line). Similar minutiae may be found in iris images for identification. Likewise, facial features may be identified and mapped via eigenfaces or similar algorithms to generate a unique mapping. The minutiae or other features may be recorded as an array, table, or other similar data structure in a biometric template 108.

To avoid requiring the user to enroll on every device, in some implementations, the biometric template 108 may be provided to a second device B 100B, such as another smartphone, tablet, desktop computer, laptop computer, wearable computer, appliance, etc. The second device 100B may similarly capture biometric data of the user 102B via a sensor 104, and process the data with a biometric processor 106 to extract a set of minutiae or features. The second device 100B may include a biometric comparator 110, which may comprise hardware or software for comparing the biometric template 108 from device A to the extracted features or minutiae generated by the processor of the second device from the second input data 102B. In many implementations, the comparison need not be exact, but rather match above a threshold. For example, the comparator 110 may determine a match if at least a predetermined number of minutiae correspond (e.g. 80%, 90%, or any other such value). In some implementations, matching the minutiae or features may comprise performing a transformation on the input dataset, such as scaling to enlarge or reduce the features (e.g. multiplying x-y coordinates by a scaling coefficient), and/or rotating the feature set (e.g. remapping the x-y coordinates to an x′-y′ axis, adding a predetermined offset to angles indicating directions of features, etc.).

Although such systems are useful for allowing password-free authentication of users, they require a secure communication channel 112 between the devices: interception of the biometric template 108 or profile during communication between the devices, or otherwise exfiltrating the template 108 or profile destroys the security of the biometric system. For example, if the template 108 represents a captured voice recording or fingerprint, a malicious attacker that intercepts the template 108 may provide it to a system as if it were a new capture 102B. Because the new capture 102B will necessarily match the intercepted template 108, the system may erroneously authenticate the attacker. The secure communication channel 112 may require strong encryption, may be slow or inefficient to utilize, and may be only theoretically secure—that is, the channel 112 may be compromised, and as a result, malicious attackers may gain access to one or both devices.

Instead, the systems and methods discussed provide for the use of biometric authentication on local or remote devices, without requiring a secure communication channel between the devices. In brief overview, in some implementations, secure biometric authentication may be accomplished by:

1. Performing an enrollment operation on a first device;

2. Encrypting the enrollment data and user credentials using a cryptography key generated using the biometric information;

3. Transferring the encrypted enrollment data to the remote device via any available communication channel regardless of its security; and

4. Regenerating the cryptography key using newly captured biometric data on the remote device, and decrypting the enrollment data and user credentials.

Once the biometric enrollment data and credentials are decrypted, the user may use any enrolled biometric feature to perform authentication (e.g. any enrolled fingers, enrolled irises, voice phrases, etc.). This allows the user to completely eliminate the use of passwords on the remote device.

In some implementations, the cryptographic key to encrypt and decrypt the enrollment data may be generated on the first device and regenerated on the second device using a fuzzy extractor on captured biometric data. While the biometric captures may vary from one capture to the other, the cryptographic key generation will be consistent with the same key (or seed for a key generator) output, as long as the new capture is close to that of the original capture (i.e. with a Hamming distance between the captures being less than a predetermined threshold: Dis(W,W′)<t).

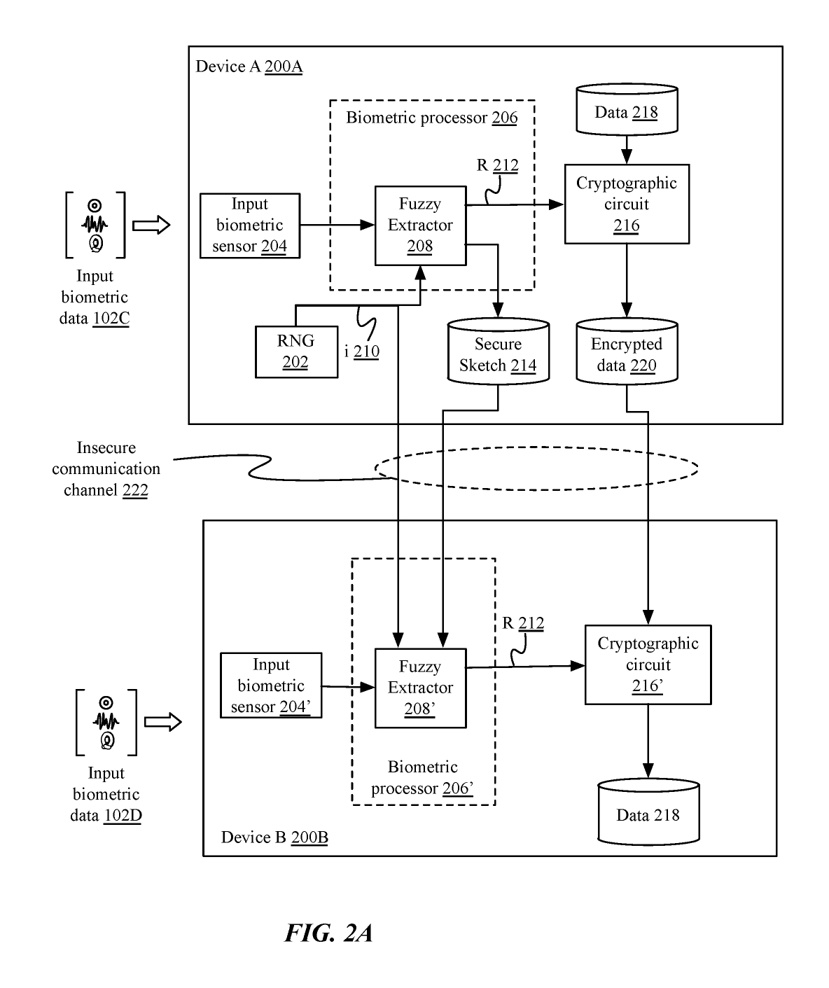

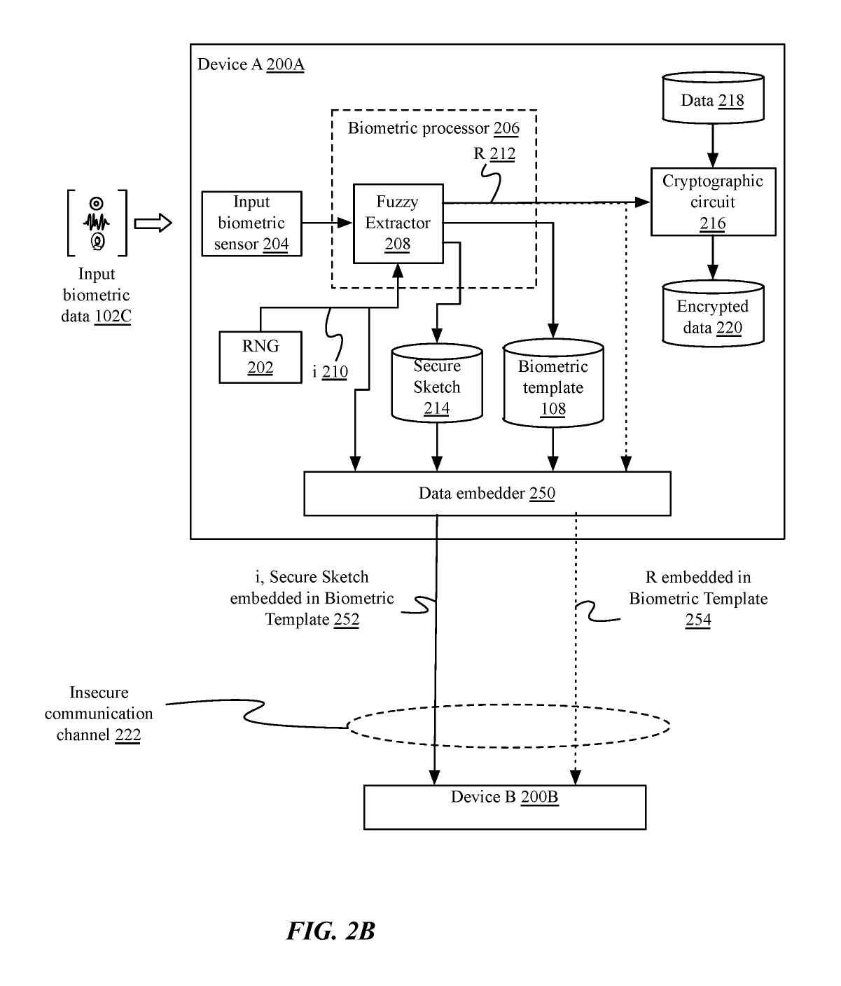

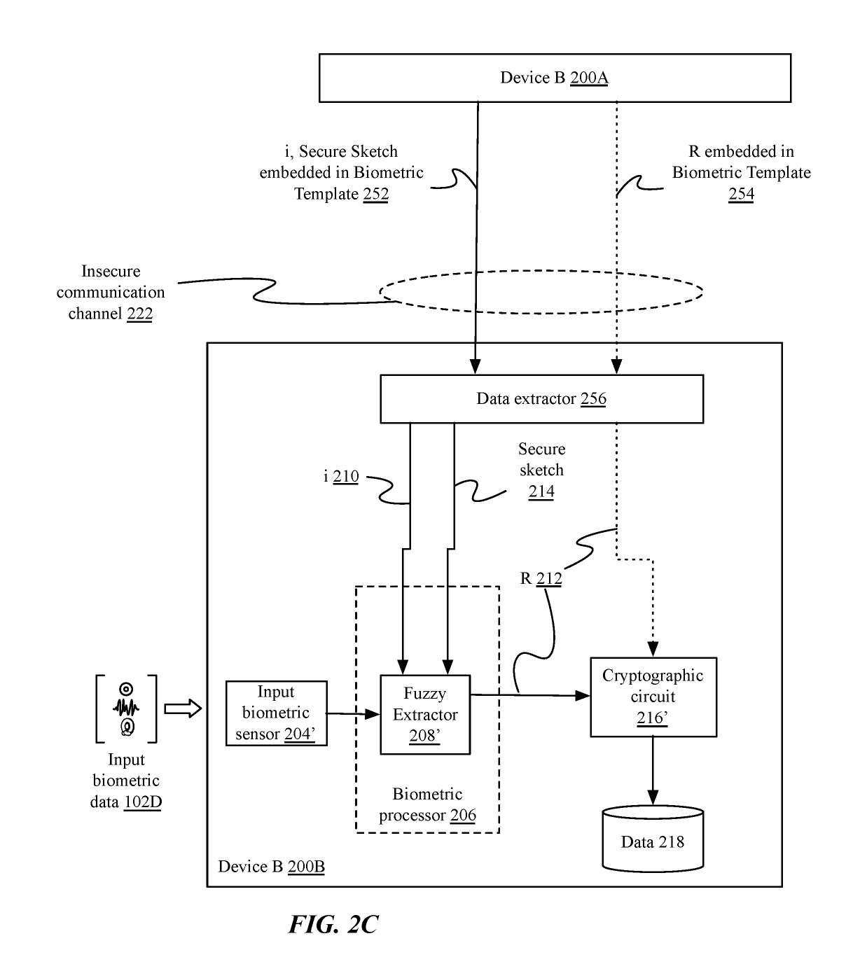

FIG. 2A is a block diagram of an implementation of a system for data security via biometric key generation and exchange via insecure data channels. A first device 200A may receive an input biometric data set 102C, such as a fingerprint, voice capture, facial capture, iris capture, etc., via a biometric sensor 204. Similar to device(s) 100 and sensor(s) 104, a device 200 may comprise any type and form of computing device, such as a smartphone, tablet computer, laptop computer, desktop computer, wearable computer, appliance, or other device; and may include a biometric sensor 204, such as a visible light and/or infrared camera, fingerprint reader, microphone, 3-dimensional sensor (e.g. stereographic cameras, sonar emitter and receiver, etc.), or any other such sensor or combination of sensors.

Device 200 may include a random number generator 202 or pseudorandom number generator for generating a random number or string i 210. In some implementations, a random or pseudorandom number generator 202 may be provided a starting seed, such as a time or date, a device address or identifier, or any other such information.

Device 200 may include a biometric processor 206. As discussed above, a biometric processor 206 may comprise hardware circuitry and/or software for receiving a biometric input and filtering the biometric input data to extract salient features or minutiae, and generate an output string or array identifying the features or minutiae. In some implementations, biometric processor 206 may include a fuzzy extractor 208. Fuzzy extractor 208 may comprise hardware circuitry or software executed by a processor of the device for generating, from an input biometric data set 102 (and optionally a random number i 210), a secure sketch 214 and output string R 212.

A secure sketch 214 is a string or randomized map extracted from input data w, such as biometric input data, such that given any similar biometric input data w′ (e.g. having Hamming distance (w, w′)<threshold t), the original input data w may be recovered. Secure sketches may sometimes be referred to as reconciliation data and may be similar in theory to error correction systems. The secure sketch may not have sufficient information on its own to generate either biometric input data w, w′, and accordingly, the secure sketch may be transmitted via a secure or insecure data channel without compromising the biometric security.

In some implementations, the secure sketch 214 may be generated as follows. W represents a distribution over a metric space M with Hardy space H_{∞}(W)=m. Error parameter δ is less than or equal to a threshold, such as ½. Parameter l is a rounded-down integer value equal to m+H₀(W)−1 (e.g. round l down so that l−m is an integer (set l=m+[(l−m)])). For each iteration of i from m to l−1 (e.g. i=m, m+1, . . . , l−1), Lᵢ=(2⁻⁽ⁱ⁺¹⁾, 2⁻ⁱ), Fᵢ: Kᵢ×M→Rᵢ is a family of universal hash functions with log|Rᵢ|=i+1−H_{t,∞}^{fuzz}(W)+log 1/δ. Lₗ=(0,2^{-l}). ext is an (\tilde{m}t, ∈) average-case extractor for \tilde{m}=H_{t,∞}^{fuzz}(W)−log H₀(W)−log 1/δ−1 with output length κ.

In some implementations, the sketch generation function (Gen_{W}) may include:
1. Input: w.
2. Find i such that Pr[W=w]∈Lᵢ.
3. If i=l then set ss=(i, w, 0);
4. Else sample K←Kᵢ and set ss=(i, Fᵢ(K, w), K).
5. Sample a uniform extractor seed seed.
6. Output key=ext(w, seed), p=(ss, seed).

Similarly, in some implementations, the reproduction function (Rep_{W}) may include:
1. Input: (w′, p=(ss, seed)).
2. Parse ss as (i, y, K).
3. If i=l then set w*=y;
4. Else
   (a) Let W*={w*|dis(w*, w′)≤t∧Pr[W=w*]∈Lᵢ}.
   (b) Find any w*∈W* such that Fᵢ(K, w*)=y; if none exists, set w*=⊥.
5. Output ext(w*, seed).

As noted above, fuzzy extractor 208 may also generate a random string seed or R 212, which may be based on or computed from the input biometric data and the random number i 210 generated by the random or pseudorandom number generator 202. In some implementations, R 212 may be provided to a cryptographic circuit 216 for encrypting data 218, such as user data, authentication data, enrollment data, or any other type and form of data to generate an encrypted data set 220. In some implementations, random number R may be used as an encryption key, such as a symmetric encryption key using any corresponding algorithm. In other implementations, random number R may be used as a seed to generate an encryption key, such as generating another symmetric key or an asymmetric key pair, such that the data 218 may be encrypted by one of the asymmetric keys (e.g. a public key). Thus in some implementations, R 212 may be provided as a seed to the pseudorandom number generator 202 for generation of a further random number (not illustrated), which may be used for encrypting the user data. In some implementations, cryptographic circuit 216 may comprise a hardware cryptographic module, such as a trusted platform module (TPM), or encryption hardware performing an encryption algorithm (e.g. Data Encryption Standard (DES), Blowfish, RSA, AES, etc.). In other implementations, cryptographic circuit 216 may comprise software executed by a processor of the device, such as executable logic for performing one or more of said encryption algorithms.

Thus, in some implementations, the system may generate a first random number i 210, a secure sketch 214, and encrypted data 220. The random number i and secure sketch alone are not enough to generate the input biometric data 102 or output random number R 212. Accordingly, this data, along with encrypted data 220, may be provided to a second device B 200B via an insecure communication channel 222, such as over the Internet, via a local transfer over a local network or LAN, via a wireless communication medium that may be overheard (e.g. cellular, microwave, WiFi, satellite, etc.), or any other such communications mediums or combinations of mediums. Additional layers of encryption (e.g. HTTPS communications, establishment of virtual private networks, etc.) may be unnecessary to maintain security of the biometric information and encrypted data 220.

Second device B 200B may receive the first random number i 210, a secure sketch 214, and encrypted data 220 via the communications channel 222. As discussed above, the random number and secure sketch alone may be insufficient to enable the device to generate the cryptographic key R 212. However, second device B 200B may receive further input biometric data 102D via an input biometric sensor 204′, which may (or may not) correspond to the input biometric data 102C of the user.

Device B 200B may include a biometric processor 206′ as discussed above, which may comprise a fuzzy extractor 208′. The fuzzy extractor may include circuitry or executable logic for a recovery feature, which may compare the input data 102D to the secure sketch 214 and input random string i 210 to regenerate the cryptographic key or seed R 212, e.g. using the reproduction function Rep_{W} discussed above. As discussed above, provided input biometric data 102D is similar to input biometric data 102C—that is, a Hamming distance between the two datasets is less than a threshold t—the fuzzy extractor 208′ may regenerate the same cryptographic key R 212. If the input datasets are not sufficiently similar (e.g. dis(W, W′)>t), then the resulting generated key R′ will be invalid and unable to decrypt the encrypted data 220. Thus, the encrypted data is protected by the user's biometric data and access by third parties is prevented.

Once the cryptographic key R 212 has been recovered, a cryptographic circuit 216′ of Device B 200B may decrypt the encrypted data 220, similar to the encryption discussed above. For example, in some implementations, key R 212 may be a symmetric encryption/decryption key. In other implementations, cryptographic circuit 216′ may generate an asymmetric key pair using R 212 as a seed, and the circuit may decrypt the encrypted data with a private key of the key pair. The cryptographic circuit may use any corresponding decryption algorithm, such as AES, SHA, Blowfish, DES, etc.

Although referred to as a cryptographic circuit, as discussed above, in many implementations, encryption and decryption may be provided by executable logic of the device. Thus, in some implementations, the cryptographic circuit may refer to a processor of the device executing said logic instructions.

In another implementation, data may be hidden within the minutiae of the biometric data by performing small shifts, such as in the least significant bits of the minutiae values. This may allow cryptographic keys, random number i, or the hidden sketch to be embedded within a biometric template. The template may then be transferred to the recipient device, obviating the need for manual entry of the secure sketch or seed i. Because the match of new biometric data to the template need not be exact to qualify as a match (e.g. 0≤dis(W,W′)<t), then small shifts in the template minutiae may allow hiding of data with only minor compromise to matching (e.g. depending on number of embedded bits of data, the increase in false negative matches may be negligible).

As discussed above, minutiae may be encoded as strings of parameter values, such as x-y coordinates and angles, for minutiae of a fingerprint; formant frequencies and timing, for minutiae of a voice print; etc. In one implementation, the least significant bits of some or all of these parameters may be adjusted according to a predetermined encoding (e.g. replacing a predetermined number of the least significant bits of each parameter with corresponding bits from the hidden data or an encoded version of the bits, etc.). To extract the hidden data, the system may similarly extract each set of replaced least significant bits and concatenate the result to generate the original input hidden data string. If the template does not contain the hidden data string or if it has been corrupted or altered, the extracted string will be invalid and generate further errors (e.g. when used to decrypt data or to compare against a new input biometric data set). In some implementations, to further hide the data, only a subset of parameters may be altered, such as an x coordinate of a first minutiae item, a y coordinate of a second minutiae item, and an angle of a third minutiae item. This may also decrease the rate of false negative matches by reducing the amount of altered data (e.g. with each minutiae point being unaltered in two parameters).

FIGS. 2B and 2C are block diagrams of such an implementation of a system for data security via biometric key generation and exchange via insecure data channels. Similar to FIG. 2A, a first device 200A may include a biometric processor 206 comprising a fuzzy extractor 208, input sensor 204, random number generator 202, and cryptographic circuit 216. The device may receive input biometric data 102C, and as discussed above, may generate a biometric template 108, as well as a secure sketch 214, and a cryptographic key or seed R 212.

Device A 200A may also include a data embedder 250. Data embedder 250 may comprise hardware circuitry such as a field programmable gate array or application-specific integrated circuit, or software such as an application, service, server, daemon, library, or other executable logic for modifying a biometric template 108 to hide data in the minutiae or parameters of the template. In some implementations, the data embedder may embed the value of i 210 and the secure sketch 214 in the minutiae of the biometric template 252. In other implementations, the data embedder may embed the value of cryptographic key or seed R 212 directly in the biometric template 254. The resulting modified template 252, 254 may be indistinguishable from other biometric template and it may not be apparent that any modification has occurred. Accordingly, the modified template 252, 254 may be transmitted via a communication channel 222 regardless of whether it is secure or insecure, without degrading security of the encrypted data 220.

Similarly, as shown in FIG. 2C, second device B 200B may comprise an input biometric sensor 204′, a biometric processor 206 comprising a fuzzy extractor 208′, and a cryptographic circuit 216′. The second device may receive a second input biometric data set 102D.

Device B 200B may also include a data extractor 256. Data extractor 256 may comprise hardware circuitry such as a field programmable gate array or application-specific integrated circuit, or software such as an application, service, server, daemon, library, or other executable logic for extracting hidden data from a modified biometric template 252, 254. In some implementations, the extractor 256 may extract and concatenate least significant bits from some or all parameters corresponding to modified parameters as discussed above. Depending on implementation, the extracted seed i 210 and secure sketch 214 may be provided to a fuzzy extractor 208′ for comparison to input biometric data 102D to recover cryptographic key or seed R 212; or the extracted key or seed R 212 may be provided directly to a cryptographic circuit 216′ for decryption of data 220 and recovery of original data 218.

Thus, by hiding data within the biometric template, the need for secure transmission of the secure sketch, seed i, and/or cryptographic key R is eliminated, while still allowing enrollment-free authentication on the second device.

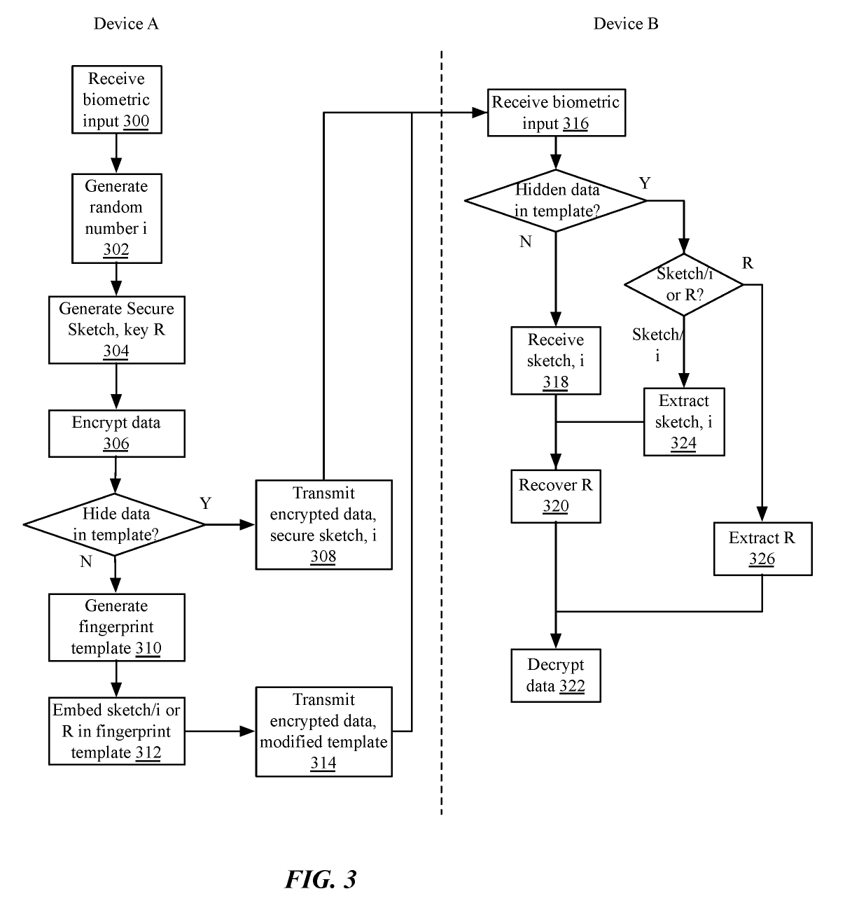

FIG. 3 is a flow chart of an implementation of a method for data security via biometric key generation and exchange via insecure data channels. As shown, during an enrollment process, a first device A may receive biometric input data at step 300. As discussed above, the input data may comprise audio, video, or images, such as fingerprint data, facial image data, iris image data, voice recordings, etc. The data may be received by a sensor of the device, such as a microphone, camera, or other sensor, and may be pre-processed in some implementations (e.g. amplified, normalized, filtered, cropped, etc.).

At step 302, in some implementations, the device may generate or receive a random number i. The random number may be generated by a random number generator or pseudorandom number generator of the device, or received from an external generator (e.g. via a local connection such as a USB connection, or received via a network). The random number may be in any appropriate format and may be used as a seed. At step 304, using the seed number and the biometric input data, a fuzzy extractor of the device may generate a secure sketch and a cryptographic key or seed R. As discussed above, the secure sketch may comprise an output of a reversible function such that the sketch may be used with similar biometric input data (e.g. having a Hamming distance from the first biometric input data less than a threshold) to regenerate the original input data. At step 306, a cryptographic circuit of the device may encrypt data with the key R or with a key of a symmetric key pair generated using R as a seed. The data may include user credential or enrollment data or other such features.

As discussed above, in some implementations, the secure sketch and seed i may be transmitted, along with the encrypted data, to a second device. The transmission may be via any appropriate means, regardless of security of the transmission (e.g. the secure sketch and seed i need not be encrypted for transmission and interception of the secure sketch may not allow a third party to regenerate the biometric input data).

In other implementations, data may be hidden in a biometric template. At step 310, the first device may generate the biometric template based on the captured biometric input data. At step 312, the first device may either embed the secure sketch and seed i in minutiae of the biometric template; or may embed the seed value or key R in the biometric template. As discussed above, embedding data in the template may comprise replacing predetermined portions of parameters of minutiae in the template (e.g. least significant bits) with portions of the data to be hidden. At step 314, the first device may transmit the encrypted data, along with the modified biometric template including the hidden data, to the second device via any suitable communication channel. Again, as discussed above, interception of the modified template may not enable a third party to decrypt the encrypted data, without a new capture of biometric input of the user.

To recover the encrypted data, in an authentication phase, at step 316, a second device may receive the encrypted data, and potentially the modified biometric template, and may capture a second biometric input data set via similar means to those discussed above in connection with step 300.

If the second device has not received a biometric template (e.g. potentially including hidden data), then at step 318, the second device may receive the secure sketch and seed value i. In some implementations, step 318 may occur simultaneously with step 316 or may occur before step 316. For example, the secure sketch and seed i may be input at the second device, and in response to receipt of the secure sketch and seed, the second device may capture the biometric input.

At step 320, a fuzzy extractor of the second device may utilize the secure sketch, seed i, and input biometric data to recover the cryptographic key or seed R. As discussed above, recovering the key may comprise reversing the encoding function utilizing the biometric input data. Provided the new input data has a Hamming distance less than a threshold t from the biometric data input at the first device and used to generate the secure sketch, the sketch may be properly decoded and the key R recovered.

At step 324, the encrypted data received from the first device may be decrypted. As discussed above, in some implementations, the recovered key R may be used as a symmetric decryption key. In other implementations, the recovered value R may be used as a seed for a pseudorandom number generator for generation of a pair of symmetric cryptographic keys, and a private key of the key pair may be used to decrypt the data. In some implementations, the encrypted and decrypted data may comprise credential or authentication data, and may be used for further authentication or enrollment of the user. In other implementations, the data may be user data, an application, identifiers such as cookies or device identifiers, or any other such information.

If the device does receive a biometric template comprising hidden data, then if the data comprises a secure sketch and seed i, at step 324, the sketch and seed i may be extracted by extracting portions of the minutiae parameters (e.g. least significant bits) and concatenating the result. The sketch and seed may then be used at step 320 to recover the cryptographic key or seed R. Similarly, if the hidden data comprises the cryptographic key or seed R, then it may be extracted at step 326, and utilized to decrypt the encrypted data at step 322. In some implementations, the embedding of the secure sketch and seed i, or cryptographic key or seed R, may be predetermined or configured (e.g. devices may always embed the sketch and seed). In other implementations, a predetermined bit or flag may be set with a predetermined value to indicate the inclusion of the secure sketch and seed as opposed to the cryptographic key or seed R. This may provide additional flexibility and security.

In some aspects, the present disclosure is directed to a method for data security via biometric key generation. The method includes receiving, by fuzzy extractor circuitry of a device, a secure sketch generated by a second device from a first biometric data set and a first random number, the first random number, and a second biometric data set. The method also includes generating from the secure sketch, the first random number, and the second biometric data set, by the fuzzy extractor circuitry, a second random number. The method also includes receiving, by cryptographic circuitry of the device, the second random number and an encrypted data set. The method also includes decrypting, by the cryptographic circuitry using the second random number, the encrypted data set to generate a decrypted data set.

In some implementations, the method includes generating, by a pseudorandom number generator of the cryptographic circuitry using the second random number as a seed input, an asymmetric key pair; and decrypting the encrypted data set further comprises decrypting the encrypted data set using a private key of the asymmetric key pair. In some implementations, the method includes decrypting the encrypted data set using the second random number by decrypting the encrypted data set with the second random number as a symmetric encryption key. In some implementations, a Hamming distance between the first biometric data set and the second biometric data set is less than a predetermined distance. In some implementations, the secure sketch and the first random number are received via an insecure communication channel.

In another aspect, the present disclosure is directed to a system for data security via biometric key generation. The system includes fuzzy extractor circuitry of a device configured to receive a secure sketch generated by a second device from a first biometric data set and a first random number, the first random number, and a second biometric data set. The fuzzy extractor is also configured to generate a second random number from the secure sketch, the first random number, and the second biometric data set. The system also includes cryptographic circuitry of the device configured to receive the second random number and an encrypted data set, and decrypt the encrypted data set using the second random number to generate a decrypted data set.

In some implementations, the cryptographic circuitry comprises a pseudorandom number generator configured to generate, using the second random number as a seed input, an asymmetric key pair. The cryptographic circuitry is further configured to decrypt the encrypted data set using a private key of the asymmetric key pair.

In some implementations, the cryptographic circuitry is further configured to decrypt the encrypted data set using the second random number as a symmetric encryption key. In some implementations, a Hamming distance between the first biometric data set and the second biometric data set is less than a predetermined distance. In some implementations, the secure sketch and the first random number are received via an insecure communication channel.

In another aspect, the present disclosure is directed to a method for data security via biometric key generation. The method includes receiving, by a biometric processor circuitry of a first device, a first biometric template comprising a biometric data set having a plurality of minutiae elements. The method also includes receiving, by the biometric processor circuitry from cryptographic circuitry of the first device, a decoding key. The method also includes modifying, by the biometric processor circuitry, a subset of the plurality of minutiae elements of the first biometric template to encode the decoding key. The method also includes generating, by the biometric processor circuitry, a second biometric template comprising the modified subset of the plurality minutiae elements; and transmitting the second biometric template to a second device, by the first device, the second device configured to extract the decoding key from the second biometric template via a comparison of the second biometric template to a corresponding input biometric data set.

In some implementations, the decoding key comprises a cryptographic key generated by the cryptographic circuitry of the device. In a further implementation, the cryptographic key comprises a symmetric key. In another further implementation, the cryptographic key comprises a private key of an asymmetric key pair. In some implementations, the decoding key comprises a secure sketch generated by the biometric processor circuitry, and a first random number.

In another aspect, the present disclosure is directed to a system for data security via biometric key generation. The system includes biometric circuitry of a first device configured to receive, from a second device, a biometric template comprising a biometric data set having a plurality of minutiae elements. The biometric circuitry is also configured to receive an input biometric data set having a second plurality of minutiae elements. The biometric circuitry is also configured to extract a modification to the biometric template performed by the second device, via a comparison of the first plurality of minutiae elements and second plurality of minutiae elements, the modification comprising an encoding of a secure sketch and a first random number. The system also includes fuzzy extractor circuitry configured to generate a second random number from the secure sketch, the first random number, and the input biometric data set. The system also includes cryptographic circuitry of the device configured to receive the second random number and an encrypted data set, and decrypt, using the second random number, the encrypted data set to generate a decrypted data set.

In some implementations, the cryptographic circuitry comprises a pseudorandom number generator configured to generate, using the second random number as a seed input, an asymmetric key pair; and the cryptographic circuitry is further configured to decrypt the encrypted data set using a private key of the asymmetric key pair.

In some implementations, the cryptographic circuitry is further configured to decrypt the encrypted data set using the second random number as a symmetric encryption key. In some implementations, a Hamming distance between the input biometric data set and the biometric template is less than a predetermined distance. In some implementations, the secure sketch and the first random number are received via an insecure communication channel.

### B. Computing and Network Environment

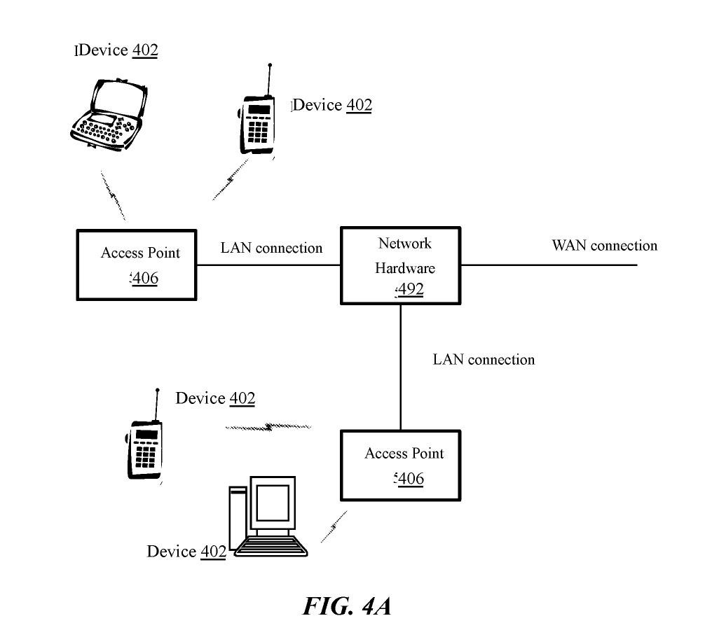

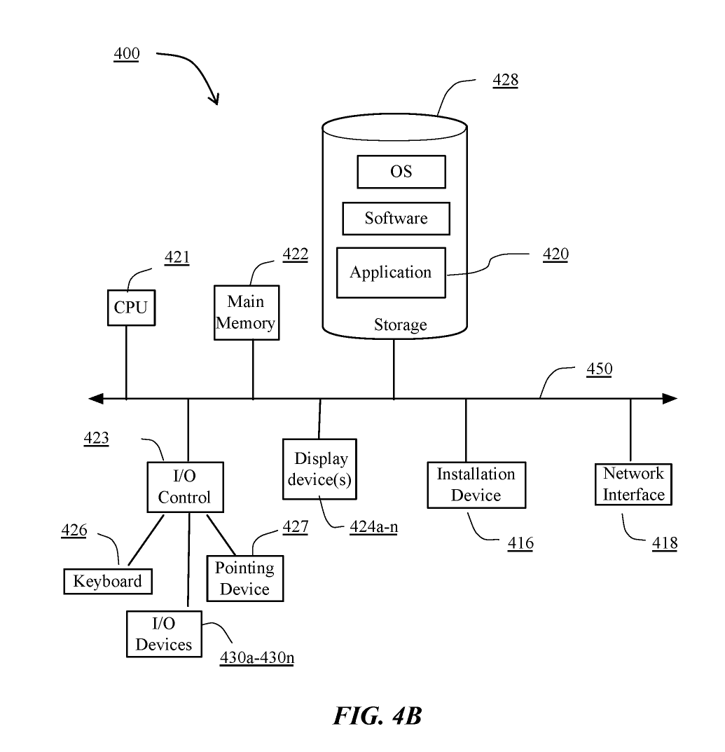

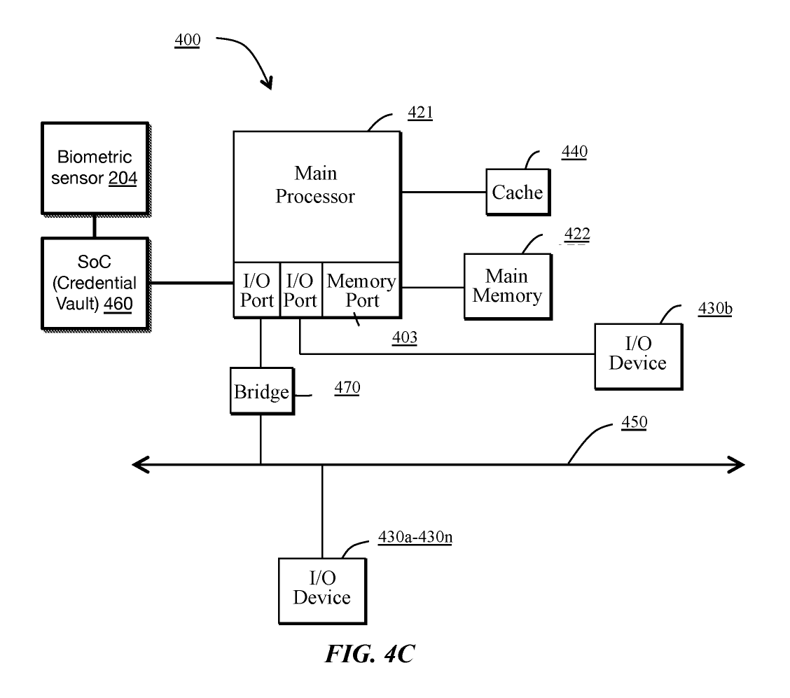

Having discussed specific embodiments of the present solution, it may be helpful to describe aspects of the operating environment as well as associated system components (e.g., hardware elements) in connection with the methods and systems described herein. Referring to FIG. 4A, an embodiment of a network environment is depicted. In brief overview, the network environment includes a wireless communication system that includes one or more access points 406, one or more wireless communication devices 402 and a network hardware component 492. The wireless communication devices 402 may for example include laptop computers 402, tablets 402, personal computers 402 and/or cellular telephone devices 402. The details of an embodiment of each wireless communication device and/or access point are described in greater detail with reference to FIGS. 4B and 4C. The network environment can be an ad hoc network environment, an infrastructure wireless network environment, a subnet environment, etc. in one embodiment

The access points (APs) 406 may be operably coupled to the network hardware 492 via local area network connections. The network hardware 492, which may include a router, gateway, switch, bridge, modem, system controller, appliance, etc., may provide a local area network connection for the communication system. Each of the access points 406 may have an associated antenna or an antenna array to communicate with the wireless communication devices 402 in its area. The wireless communication devices 402 may register with a particular access point 406 to receive services from the communication system (e.g., via a SU-MIMO or MU-MIMO configuration). For direct connections (e.g., point-to-point communications), some wireless communication devices 402 may communicate directly via an allocated channel and communications protocol. Some of the wireless communication devices 402 may be mobile or relatively static with respect to the access point 406.

In some embodiments an access point 406 includes a device or module (including a combination of hardware and software) that allows wireless communication devices 402 to connect to a wired network using Wi-Fi, or other standards. An access point 406 may sometimes be referred to as an wireless access point (WAP). An access point 406 may be configured, designed and/or built for operating in a wireless local area network (WLAN). An access point 406 may connect to a router (e.g., via a wired network) as a standalone device in some embodiments. In other embodiments, an access point can be a component of a router. An access point 406 can provide multiple devices 402 access to a network. An access point 406 may, for example, connect to a wired Ethernet connection and provide wireless connections using radio frequency links for other devices 402 to utilize that wired connection. An access point 406 may be built and/or configured to support a standard for sending and receiving data using one or more radio frequencies. Those standards, and the frequencies they use may be defined by the IEEE (e.g., IEEE 802.11 standards). An access point may be configured and/or used to support public Internet hotspots, and/or on an internal network to extend the network's Wi-Fi signal range.

In some embodiments, the access points 406 may be used for (e.g., in-home or in-building) wireless networks (e.g., IEEE 802.11, Bluetooth, ZigBee, any other type of radio frequency based network protocol and/or variations thereof). Each of the wireless communication devices 402 may include a built-in radio and/or is coupled to a radio. Such wireless communication devices 402 and/or access points 406 may operate in accordance with the various aspects of the disclosure as presented herein to enhance performance, reduce costs and/or size, and/or enhance broadband applications. Each wireless communication devices 402 may have the capacity to function as a client node seeking access to resources (e.g., data, and connection to networked nodes such as servers) via one or more access points 406.

The network connections may include any type and/or form of network and may include any of the following: a point-to-point network, a broadcast network, a telecommunications network, a data communication network, a computer network. The topology of the network may be a bus, star, or ring network topology. The network may be of any such network topology as known to those ordinarily skilled in the art capable of supporting the operations described herein. In some embodiments, different types of data may be transmitted via different protocols. In other embodiments, the same types of data may be transmitted via different protocols.

The communications device(s) 402 and access point(s) 406 may be deployed as and/or executed on any type and form of computing device, such as a computer, network device or appliance capable of communicating on any type and form of network and performing the operations described herein. FIGS. 4B and 4C depict block diagrams of a computing device 400 useful for practicing an embodiment of the wireless communication devices 402 or the access point 406. As shown in FIGS. 4B and 4C, each computing device 400 includes a central processing unit 421, and a main memory unit 422. As shown in FIG. 4B, a computing device 400 may include a storage device 428, an installation device 416, a network interface 418, an I/O controller 423, display devices 424a-424n, a keyboard 426 and a pointing device 427, such as a mouse. The storage device 428 may include, without limitation, an operating system and/or software. As shown in FIG. 4C, each computing device 400 may also include additional optional elements, such as a memory port 403, a bridge 470, one or more input/output devices 430a-430n (generally referred to using reference numeral 430), and a cache memory 440 in communication with the central processing unit 421.

The central processing unit 421 is any logic circuitry that responds to and processes instructions fetched from the main memory unit 422. In many embodiments, the central processing unit 421 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 400 may be based on any of these processors, or any other processor capable of operating as described herein.

Main memory unit 422 may be one or more memory chips capable of storing data and allowing any storage location to be directly accessed by the microprocessor 421, such as any type or variant of Static random access memory (SRAM), Dynamic random access memory (DRAM), Ferroelectric RAM (FRAM), NAND Flash, NOR Flash and Solid State Drives (SSD). The main memory 422 may be based on any of the above described memory chips, or any other available memory chips capable of operating as described herein. In the embodiment shown in FIG. 4B, the processor 421 communicates with main memory 422 via a system bus 450 (described in more detail below). FIG. 4C depicts an embodiment of a computing device 400 in which the processor communicates directly with main memory 422 via a memory port 403. For example, in FIG. 4C the main memory 422 may be DRDRAM.

FIG. 4C depicts an embodiment in which the main processor 421 communicates directly with cache memory 440 via a secondary bus, sometimes referred to as a backside bus. In other embodiments, the main processor 421 communicates with cache memory 440 using the system bus 450. Cache memory 440 typically has a faster response time than main memory 422 and is provided by, for example, SRAM, BSRAM, or EDRAM. In the embodiment shown in FIG. 4C, the processor 421 communicates with various I/O devices 430 via a local system bus 450. Various buses may be used to connect the central processing unit 421 to any of the I/O devices 430, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 424, the processor 421 may use an Advanced Graphics Port (AGP) to communicate with the display 424. FIG. 4C depicts an embodiment of a computer 400 in which the main processor 421 may communicate directly with I/O device 430b, for example via HYPERTRANSPORT, RAPIDIO, or INFINIBAND communications technology. FIG. 4C also depicts an embodiment in which local busses and direct communication are mixed: the processor 421 communicates with I/O device 430a using a local interconnect bus while communicating with I/O device 430b directly.

A wide variety of I/O devices 430a-430n may be present in the computing device 400. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 423 as shown in FIG. 4B. The I/O controller may control one or more I/O devices such as a keyboard 426 and a pointing device 427, e.g., a mouse or optical pen. Furthermore, an I/O device may also provide storage and/or an installation medium 416 for the computing device 400. In still other embodiments, the computing device 400 may provide USB connections (not shown) to receive handheld USB storage devices such as the USB Flash Drive line of devices manufactured by Twintech Industry, Inc. of Los Alamitos, Calif.

Referring again to FIG. 4B, the computing device 400 may support any suitable installation device 416, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 400 may further include a storage device, such as one or more hard disk drives or redundant arrays of independent disks, for storing an operating system and other related software, and for storing application software programs such as any program or software 420 for implementing (e.g., configured and/or designed for) the systems and methods described herein. Optionally, any of the installation devices 416 could also be used as the storage device. Additionally, the operating system and the software can be run from a bootable medium.

Furthermore, the computing device 400 may include a network interface 418 to interface to the network 404 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 400 communicates with other computing devices 400′ via any type and/or form of gateway or tunneling protocol such as Secure Socket Layer (SSL) or Transport Layer Security (TLS). The network interface 418 may include a built-in network adapter, network interface card, PCMCIA network card, card bus network adapter, wireless network adapter, USB network adapter, modem or any other device suitable for interfacing the computing device 400 to any type of network capable of communication and performing the operations described herein.

In some embodiments, the computing device 400 may include or be connected to one or more display devices 424a-424n. As such, any of the I/O devices 430a-430n and/or the I/O controller 423 may include any type and/or form of suitable hardware, software, or combination of hardware and software to support, enable or provide for the connection and use of the display device(s) 424a-424n by the computing device 400. For example, the computing device 400 may include any type and/or form of video adapter, video card, driver, and/or library to interface, communicate, connect or otherwise use the display device(s) 424a-424n. In one embodiment, a video adapter may include multiple connectors to interface to the display device(s) 424a-424n. In other embodiments, the computing device 400 may include multiple video adapters, with each video adapter connected to the display device(s) 424a-424n. In some embodiments, any portion of the operating system of the computing device 400 may be configured for using multiple displays 424a-424n. One ordinarily skilled in the art will recognize and appreciate the various ways and embodiments that a computing device 400 may be configured to have one or more display devices 424a-424n.

In further embodiments, an I/O device 430 may be a bridge between the system bus 450 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

As shown in FIG. 4C, in some implementations, a host-isolated co-processor (e.g. system-on-chip credential vault 460) may perform the secure sketch generation and/or reproduction methods discussed above. This may provide additional security by separating and isolating these functions from the processor of the computing device 400, as well as providing easier implementation for manufacturers of computing devices 400. Furthermore, SoC 460 may be tamper resistant or hardened against intrusion, providing additional physical security for biometric data on the device. SoC 460 may include, in addition to a co-processor, any of the components discussed above in connection with FIGS. 2A-2C, including a biometric processor 206, fuzzy extractor 208, template storage 108, data storage 218, cryptographic circuit 216, and/or a random or pseudorandom number generator 202.

A computing device 400 of the sort depicted in FIGS. 4B and 4C may operate under the control of an operating system, which control scheduling of tasks and access to system resources. The computing device 400 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 400 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 400 has sufficient processor power and memory capacity to perform the operations described herein.

In some embodiments, the computing device 400 may have different processors, operating systems, and input devices consistent with the device. For example, in one embodiment, the computing device 400 is a smart phone, mobile device, tablet or personal digital assistant. In still other embodiments, the computing device 400 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 400 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A method for data security via biometric key generation comprising;
receiving, by fuzzy extractor circuitry of a device, a secure sketch generated by a second device from a first biometric data set and a first random number, the first random number, and a second biometric data set;
generating from the secure sketch, the first random number, and the second biometric data set, by the fuzzy extractor circuitry, a second random number;
receiving, by cryptographic circuitry of the device, the second random number and an encrypted data set; and
decrypting, by the cryptographic circuitry using the second random number, the encrypted data set to generate a decrypted data set.

2. The method of claim 1, further comprising generating, by a pseudorandom number generator of the cryptographic circuitry using the second random number as a seed input, an asymmetric key pair; and
wherein decrypting the encrypted data set further comprises decrypting the encrypted data set using a private key of the asymmetric key pair.

3. The method of claim 1, wherein decrypting the encrypted data set using the second random number comprises decrypting the encrypted data set with the second random number as a symmetric encryption key.

4. The method of claim 1, wherein a Hamming distance between the first biometric data set and the second biometric data set is less than a predetermined distance.

5. The method of claim 1, wherein the secure sketch and the first random number are received via an insecure communication channel.

6. A system for data security via biometric key generation comprising:
fuzzy extractor circuitry of a device configured to:
receive a secure sketch generated by a second device from a first biometric data set and a first random number, the first random number, and a second biometric data set, and
generate a second random number from the secure sketch, the first random number, and the second biometric data set; and
cryptographic circuitry of the device configured to:
receive the second random number and an encrypted data set, and
decrypt the encrypted data set using the second random number to generate a decrypted data set.

7. The system of claim 6, wherein the cryptographic circuitry comprises a pseudorandom number generator configured to generate, using the second random number as a seed input, an asymmetric key pair; and
wherein the cryptographic circuitry is further configured to decrypt the encrypted data set using a private key of the asymmetric key pair.

8. The system of claim 6, wherein the cryptographic circuitry is further configured to decrypt the encrypted data set using the second random number as a symmetric encryption key.

9. The system of claim 6, wherein a Hamming distance between the first biometric data set and the second biometric data set is less than a predetermined distance.

10. The system of claim 6, wherein the secure sketch and the first random number are received via an insecure communication channel.

11. A method for data security via biometric key generation, comprising:
receiving, by a biometric processor circuitry of a first device, a first biometric template comprising a biometric data set having a plurality of minutiae elements;
receiving, by the biometric processor circuitry from cryptographic circuitry of the first device, a decoding key;
modifying, by the biometric processor circuitry, a subset of the plurality of minutiae elements of the first biometric template to encode the decoding key;
generating, by the biometric processor circuitry, a second biometric template comprising the modified subset of the plurality minutiae elements; and
transmitting the second biometric template to a second device, by the first device, the second device configured to extract the decoding key from the second biometric template via a comparison of the second biometric template to a corresponding input biometric data set.

12. The method of claim 11, wherein the decoding key comprises a cryptographic key generated by the cryptographic circuitry of the device.

13. The method of claim 12, wherein the cryptographic key comprises a symmetric key.

14. The method of claim 12, wherein the cryptographic key comprises a private key of an asymmetric key pair.

15. The method of claim 11, wherein the decoding key comprises a secure sketch generated by the biometric processor circuitry and a first random number.

16. A system for data security via biometric key generation comprising:
biometric circuitry of a first device configured to:
receive, from a second device, a biometric template comprising a biometric data set having a plurality of minutiae elements,
receive an input biometric data set having a second plurality of minutiae elements,
extract a modification to the biometric template performed by the second device, via a comparison of the first plurality of minutiae elements and second plurality of minutiae elements, the modification comprising an encoding of a secure sketch and a first random number;
fuzzy extractor circuitry configured to generate a second random number from the secure sketch, the first random number, and the input biometric data set; and
cryptographic circuitry of the device configured to:
receive the second random number and an encrypted data set, and
decrypt, using the second random number, the encrypted data set to generate a decrypted data set.

17. The system of claim 16, wherein the cryptographic circuitry comprises a pseudorandom number generator configured to generate, using the second random number as a seed input, an asymmetric key pair; and
wherein the cryptographic circuitry is further configured to decrypt the encrypted data set using a private key of the asymmetric key pair.

18. The system of claim 16, wherein the cryptographic circuitry is further configured to decrypt the encrypted data set using the second random number as a symmetric encryption key.

19. The system of claim 16, wherein a Hamming distance between the input biometric data set and the biometric template is less than a predetermined distance.

20. The system of claim 16, wherein the secure sketch and the first random number are received via an insecure communication channel.
